(19) United States
(12) Patent Application Publication
(10) Pub. No.: US 2005/0188424 A1
(43) Pub. Date: Aug. 25, 2005

(54) System and method for trading digital content and ownership transfer

(76) Inventor: Adrian S. Kizyma, La Crescenta, CA (US)

Correspondence Address: CHRISTIE, PARKER & HALE, LLP, PO BOX 7068, PASADENA, CA, 91109-7068, US

(21) Appl. No.: 11/067,636

(22) Filed: Feb. 25, 2005

Related U.S. Application Data
(60) Provisional application No. 60/547,983, filed on Feb. 25, 2004.
(60) Provisional application No. 60/574,614, filed on May 25, 2004.

(51) Int. Cl. H04L 9/00

(52) U.S. Cl. 726/26

(57) ABSTRACT

A method and system for the transfer of content. In some embodiments a server maintains digital copies of content and limits access to digital content based on ownership. In some embodiments a server provides for the ownership transfer of digital and physical copies of content stored in the system.

### CROSS-REFERENCE TO RELATED APPLICATIONS

This application claims the benefit of U.S. Provisional Application No. 60/574,614, filed May 25, 2004 and 60/547,983 filed, Feb. 25, 2004, the disclosures of which are incorporated by reference herein.

### BACKGROUND OF THE INVENTION

A system and method for trading digital content and ownership transfer are generally discussed herein with specific discussion relating to trading audio compact discs (CDs), Digital Versatile Discs (DVDs), digital storage systems, original electronic (digital) content and other digital content.

### SUMMARY OF THE INVENTION

Aspects of the invention provides a system and method for trading digital content, such as audio CDs, or DVDs, and other digital content. However, aspects of the invention are not limited to CDs or DVDs and may be employed to trade other types of digital content including books, magazines, software, firmware, computer games, and the like. Further, one aspect of the invention trades any type of content which can be converted into a digital format, such as analog audio cassettes, sheet music, photographs, and the like.

In certain embodiments of the invention, a trading system enables subscribed members (members) to trade digitized content (content) with other subscribed members. In some embodiments the system is configured so as to require a one-to-one relationship between a unique physical media copy of any content and a single member who owns the unique physical media copy of the content. The system may be configured so as to require a one-to-one-to-one relationship between a unique physical media copy of any content, the digitized copy of the unique physical media copy, and a single member who owns the unique physical media copy of the content. The system may be configured so as to require one-to-one relationship between a unique electronic (or digital) media copy of any content and a single member who owns the unique original electronic (or digital) media copy of the content. The system may be configured so as to require a one-to-one-to-one relationship between a unique electronic (or digital) media copy of any content, the duplicate digital copy of the unique original electronic (or digital) media copy and a single member who owns the unique original electronic (or digital) media copy of the content. Such a system may be useful to provide compliance with copyright laws, and to assist owners of content to trade or sell and transfer ownership of their property.

Information pertaining to the ownership of content, such as ownership history, custody of either physical and/or digital media containing the content, and other related details may be stored by the system. Further, historical ownership information may be encrypted and may also follow the media during transfers of ownership or custody.

A member subscribes to the trading service and provides various account information such as their name, mailing address, email address, billing and credit card information, etc. In some embodiments Members' identities are verified by the system provider using a number of known techniques. Members may also purchase new content from the system provider should desired content not be available from another member.

Members submit content for trading to the system by filling out a form detailing the content to be traded. The form may be filled out electronically via a website or a preprinted paper form. Information about the content can include such fields as the name of the content, the author of the content, the type of physical media of the content (e.g., CD, DVD, cassette, etc.). Once the information detailing the content is provided, the member delivers the physical or digital copy, or has a third party or other source deliver a physical or digital copy of the content to the trading system provider. The member also indicates how many points, or a minimum of how many points, the member is willing to accept to trade the content to another member.

In some embodiments of the invention a bar-code, magnetic strip, or other similar device is used to facilitate faster tracking and input of received physical content. Delivery to the system provider is achieved by regular mail, or other shipping method. Delivery of digital content from the user, third party, or other source is also facilitated via a communications network. In some embodiments of the invention the system provider operates remote locations for receiving either physical or digital content, including automated receiving systems that verify the submission is authentic thereby allowing member instant access to the submitted content. Further, the system provider can confirm the delivered copy of the content is the same as was described in the submitted form, that the content is authentic, and that the physical copy of the content is not defective, etc. Moreover, the system, including automated remote receiving systems will accommodate content stored on multiple electronic formats, such as a computer chip, disc drive, memory chip, memory stick, or other electronic digital storage device, as well as on physical media such as DVD or CDs or the like.

Upon receipt of the content, the system provider may digitize the content for storage in a content library, if the content is not already in a digitized format. In one embodiment of the invention the member digitizes the content for storage. The system provider may also save any artwork from the contents' packaging such as a CD or album cover, or may optionally obtain the artwork from another source. The provider may then update the content database to reflect that the content was received from the member and stored in the content library. If a one-to-one relationship between each physical or copy of the content and a single member is not required, the provider may simply update the content database to reflect that the content was received by the member, but not enter a duplicate copy of the received content into the content library. The provider may also simply update the content database to reflect that the electronic (or digital) content was received by the member and enter the copy of the received content into the content library. Once the content database is updated to reflect that the member has submitted their copy of the content, the member can allow its copy to be traded, or ownership of the content to be transferred to another member in exchange for a number of points or other means of credit or valuable consideration. Upon receipt of the content, the provider may also, pre-print and physically or electronically send the owner a label to affix to the received physical content for future identification by the system. Similarly, pre-printed labels may also be physically or electronically sent to members who obtain content electronically, as described below, for future identification by the system. Moreover, after a member obtains content electronically, as described below, appropriate blank physical media with pre-printed labels may be sent to the member so that the member can store and use the obtained content on the blank physical media. This allows for easy future identification by the system of the stored physical content and the member who submits it.

In one embodiment Members of the system request to trade points, credit or other valuable consideration for desired content. That is, to purchase content owned by another member, or transfer ownership of stored physical or digital content, or both. Accordingly, members may search the content database for desired content. The search may be keyed to any of the content database fields, such as title of content, author, date, genre, format, points requested, or other fields. Once a member selects content to trade or purchase, the system updates the content database moving ownership to the new member. If the member desires to receive the physical copy of the content the provider may ship the physical copy of the content to the member.

A member may also reserve content that is not yet available on the system. In one embodiment the reserving member specifies the number of trading points they are willing to exchange for the content and as soon as another member submits the content (and assuming the number of trade points is adequate) the transaction is automatically completed upon submission. Similarly, members can search not only what content is available, but what content is desired, and how many points they are willing to trade for it.

The trading system may employ a system of trading points. A member may assign a trade point value to their content; the trade point value indicates the number of points they will trade the content for. The greater the demanded points the greater the value ascribed to the content by its owner. Additionally, a member may indicate that they will not trade content for any points. Further, a member may also indicate that they will entertain offers to trade content, but not expressly assign any trade point value.

In one embodiment of the present invention members may purchase trading points with money, or for other valuable consideration that the system provider may accept. Similarly, the system provider may provide valuable consideration to members in exchange for their content. In an embodiment of the present invention members may sell or trade their trading points with other members or nonmembers.

In one embodiment of the present invention members may trade portions of content (i.e., songs from a music album) without trading the entire content. The provider may also elect to allow members to trade the remaining portion of the content to another member. A Member who owns a portion of content (i.e., several songs from a music album) may purchase the remaining portions thereby making the content whole again. Portions of the content may be treated as fungible (i.e., the member need not purchase the same versions of the songs to make the content whole again), or non-fungible (i.e., in order to make the make the content whole again all the original potions of the content must be tracked and purchased). Additionally, members may also rent or even lease their content or portions of their content.

In one embodiment of the invention members may make use of the digitized version of the content while it is stored in the content library. This allows the system to serve not only as a trading space for members, but also as a storage space and playback service for members. In one embodiment of the invention the content database is programmed to limit access to the content to the owning member, or to allow other various levels of access by other members. Limiting access is achieved by setting a database entry corresponding to the content, and as necessary to the content owner.

In one embodiment of the present invention the system may configured so as to allow and facilitate competitive bidding for content. In one embodiment members may simply propose direct trades of content. It will be apparent to one skilled in the art that the system described herein is not limited to digitized content, but may be extended to a number of types of properties, including: timeshare or fractional ownership, memorabilia and other forms of collectables, automobiles, etc. Other alternatives and embodiments for practicing the invention are also described herein and further discussed below in the Detailed Description section.

### BRIEF DESCRIPTION OF THE DRAWINGS

These and other features and aspects of the invention will become appreciated as the same become better understood with reference to the specification, claims and appended drawings wherein:

FIG. 1 details the overall architecture of one embodiment of the system.

FIG. 2 depicts particular steps during content submission and verification.

FIG. 3 depicts particular steps during the sale of content.

FIG. 4 details the overall architecture of one embodiment of the system.

FIG. 5 depicts particular steps during the purchase of content from an outside system.

### DETAILED DESCRIPTION

The detailed description set forth below in connection with the appended drawings is intended as a description of the presently preferred embodiments of the content trading system provided in accordance with aspects of the invention and is not intended to represent the only forms in which the invention may be constructed or utilized. The description sets forth the features and steps for constructing and using aspects of the invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

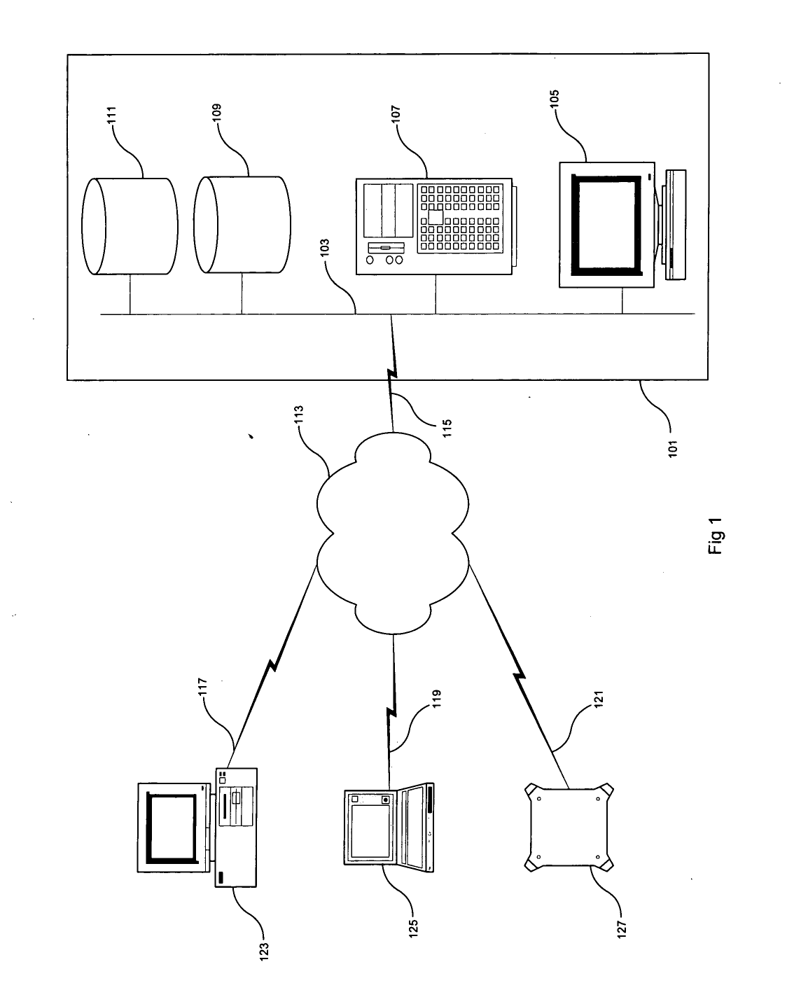

Turning to FIG. 1, a trading system 101 for trading digital content such as audio CDs or DVDs, and other digital content, is connected via a communications link 115 to computer network 113. By way of example, in one embodiment computer network 113 may be the Internet, a corporate or campus intranet, or the like. Trading system 101 is comprised of several components including a system network 103, a web server 107, a digitizing server 105, a content data base 109, and a content library 111. Trading system 101 communicates with a number of members via one or more electronic devices 123, 125, 127, each connected to the Internet 113 via communications links 117, 119, and 121, respectively. In one embodiment electronic devices 123, 125, 127, include personal computers, mobile or wireless devices such as iPods or cellular telephones, or cable or satellite television set-top boxes, or the like.

The web server 107 provides the interface which enables members to interact with the trading system 101. The web server 107 may be programmed to facilitate the storage and retrieval of data into and out of the content database 109. The web server 107 may also be programmed to authenticate each member as they access the trading system 101 by way of information stored in the content database 109.

Content database 109 is a relational database that stores information about each member and the content that member owns which is stored in the trading system 101. Further, content database 109 may be programmed with a number of fields or data fields or elements pertaining to each member's media items (content). The data stored for each content item owned by a member may include data such as the content's title, the author, the year of origin, genera, origin of original purchase, ownership history, and other descriptive information pertaining to the content. In addition, the number of trading points a member desires in exchange for his ownership rights in the content may also be stored in content database 109.

Content library 111 stores content items owned by members. In one embodiment of the invention the digitized content includes MP3 files for CD audio, MPEG files for DVD videos. Other embodiments of the invention include other types of content items, which will be understood by one skilled in the art. Content may be comprised of a single or multiple files, and may be in any one of number of physical or electronic forms. The content library 111 is interconnected to the other elements of trading system 101 via system network 103. Digitized content stored in the content library 111 may be accessible by members via the Internet 113 for member convenience.

Computer 123 connects via communications link 117, the Internet 113, and the communications link 115 to the web server 107. The member provides identifying information to web server 107, which web server 107 verifies in content database 109. Once the member is authenticated the member may indicate what content the member will submit to the trading system 101 for storage and possible trading. In one embodiment the member supplies this information via an online form which is processed by web server 107. The information about the content may include, the title of the compact disc, the author, the year of recording, or the like, and are stored in the content database 107. After the member has submitted the form indicating what content they are going to submit, the member ships the physical media (i.e. the CD) to the system operator. Content not stored on physical media, or electronically controlled media, may be submitted electronically. Upon receipt of the electronically submitted content the original copy may be destroyed or otherwise controlled. In one embodiment of the invention content is submitted directly from a third or fourth party to the system by a member. In one embodiment information pertaining to the submitted content is also submitted to the system.

Upon receipt of non-digital physical media by the trading system operator the content is digitized using digitizing server 105 and the resulting digitized file is stored in content library 111. Similarly, digital physical media received by the trading system operator is stored in content library 111. Additionally, the content database 109 is updated to reflect that the physical CD was received, and in some embodiments where the content was received from. After these steps are complete the member may access the content from the content library 111 and may also play the digitized copy of the content directly on their personal computer 123. In some embodiments content database 107 is programmed to limit access to the content to the owning member, or in some cases to other members. Limiting access is achieved by use of an additional database field in content database 107 corresponding to content access rights. The stored value indicates the access rights, if any, for stored content.

If a member elects to sell or trade the content stored in the trading system 101 the member indicates the number of trading points which they will accept in exchange for their content. The minimum trading points desired is stored in the content database 109 and associated with the member, and the content. The number of minimum trading points may be changed by members.

If a second member using personal computer 125 desires to obtain the first member's copy of the content for the indicated number of trading points the second member may purchase the content so long as the second member has enough trading points in their account. To complete the sale the buying member instructs web server 107 to deduct the required trading points from the buyer member's account and credit the points to the seller's account. Next, the web server updates the database server 109 to reflect that the second member is the owner of the content.

After the sale is consummated the second member enjoys all rights to both the physical media containing the content, or the original electronic version, as well as to the digitized version of the content stored in the content library 111. The second member may play or stream the digitized content directly from the content library 111, trade or otherwise transfer ownership in the content to another member, or as in one embodiment create a physical copy of the content or copy a version of the content onto physical media for use. The system may be programmed to track copying of system content by members and to subsequently restrict future trading until all copies have been erased by the member. Such tracking may be achieved via digital watermarking, or other techniques.

A member may download from system database 109 artwork associated with its content. The artwork may be sized for printing on labels to be affixed to physical media. For example, if the content is a DVD, the artwork is sized as a label for affixing to a physical DVD or to fit inside a DVD jewel case, or the like. Additionally, labels or other reports may be generated containing content information. Labels and reports may contain third-party advertising and the system may key the third-party advertising to the content (i.e., if the content is an education cooking program the third-party advertising could conceivably be for a cookbook, or similar goods. Labels may also be formatted to serve as a shipping envelope, namely formatted to contain the shipping address of the system provider, return address of the submitting member and an area for affixing postage.

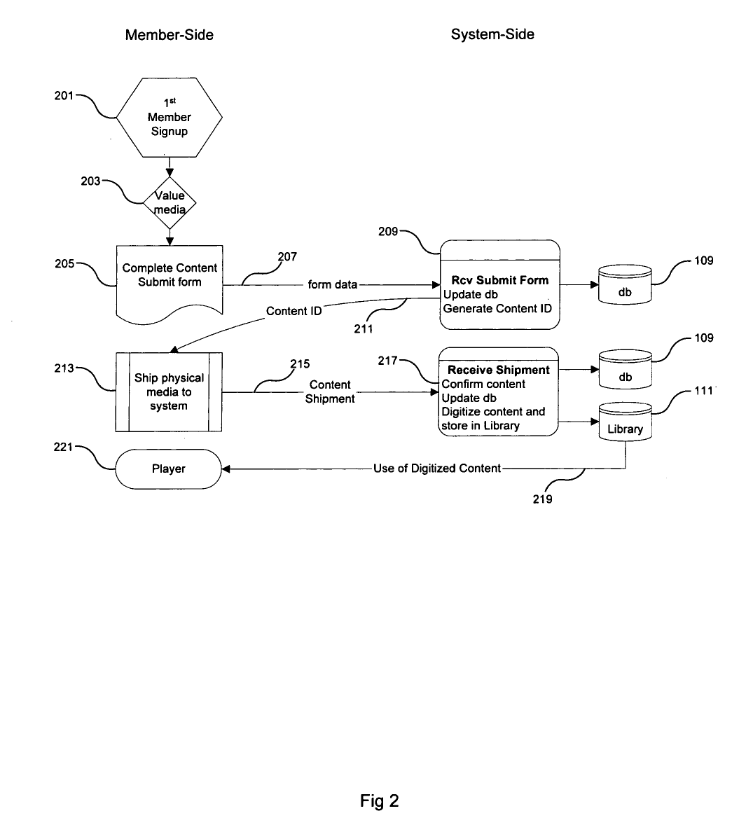

The process for submitting content to the system by a first member 201 is detailed in FIG. 2. In step 201 the first member signs up with the trading system by providing membership information such as the member's first name, last name, billing address, credit card information, and the like. If the first member chooses to trade or sell his content the member may assign a trading point value in step 203. The member may subsequently assign or change the trading point value via an online member interface (not depicted). Additionally, the member may chose not to trade their content for any number of trading points, or merely to entertain offers without specifying any particular value. The assigned trading point value represents the value of the content, and also the number of trading points the first member will sell its content for.

In step 205 the first member completes a content submission form detailing information about the content. The content submission form may be filled out online via a web server, or a paper form filled out with a pencil or pen. The content submission form contains information pertaining to the content such as title, artist, physical media, etc. Once the content submission form is completed the member transmits the form in step 207 to the trading system. The transmission may be by way of facsimile, postal mail, or electronically via communications link 115 and computer network 113.

The content submission form is received in step 209 by the system and the information is input into the content database 109. A unique content ID is generated and communicated to the member in step 211. The unique content ID is used by the system to identify the content upon receipt. Upon receipt of the content ID the member affixes the content ID to the physical media in step 213 and ships the physical media to the system operator in step 215. Shipments may contain more than one content item as members may ship in multiple content items at a time.

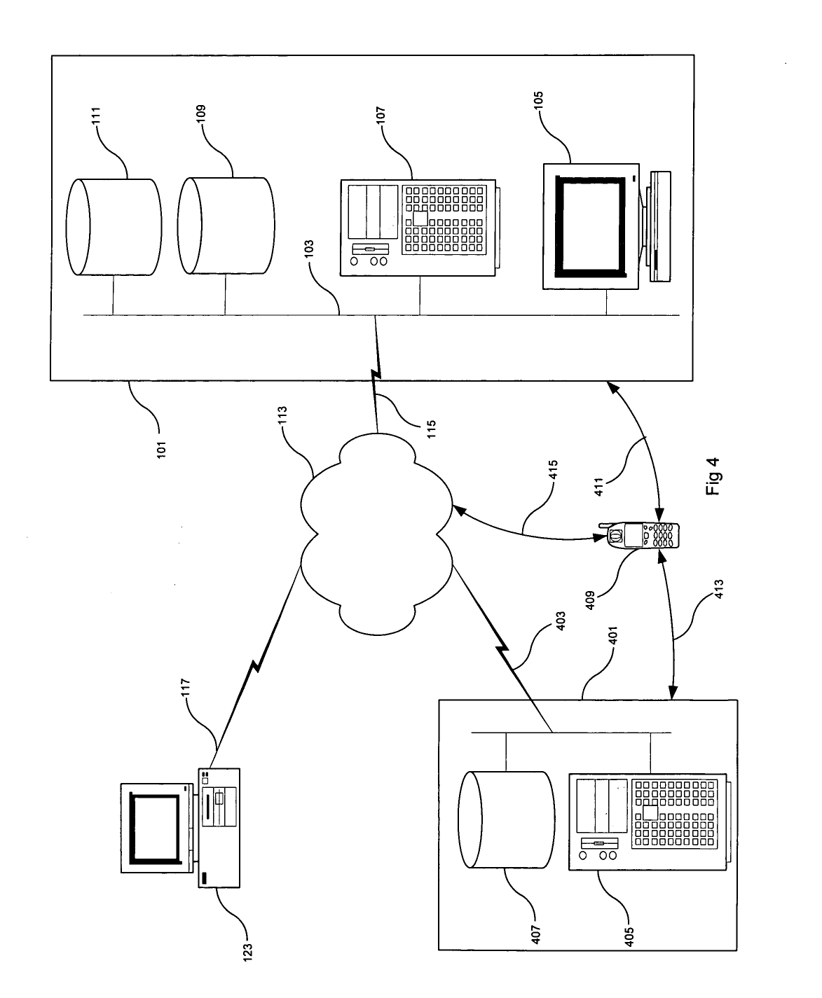

The trading system operator receives the content in step 217 and confirms that the content is that which was identified by the member on the content submission form in step 205. Once confirmed, the content database 109 is updated indicating that the content has been received by the system. The content is also digitized and stored in content library 111. In one embodiment of the invention a historical watermark is applied to the content. The member may now access their content directly from the content library 111, as step 219 illustrates. For example, in step 221 the member playbacks their content using a digital player. Digital player 221 may be located within the member's personal computer as depicted in FIG. 1, or within a mobile device as depicted in FIG. 4 as discussed further below, or within a multimedia set-top box such as a cable or satellite television box, or the like. The member may also print labels for the content. Additionally, the member may also print the content's unique content ID to facilitate subsequent resubmission of the content to the system provider.

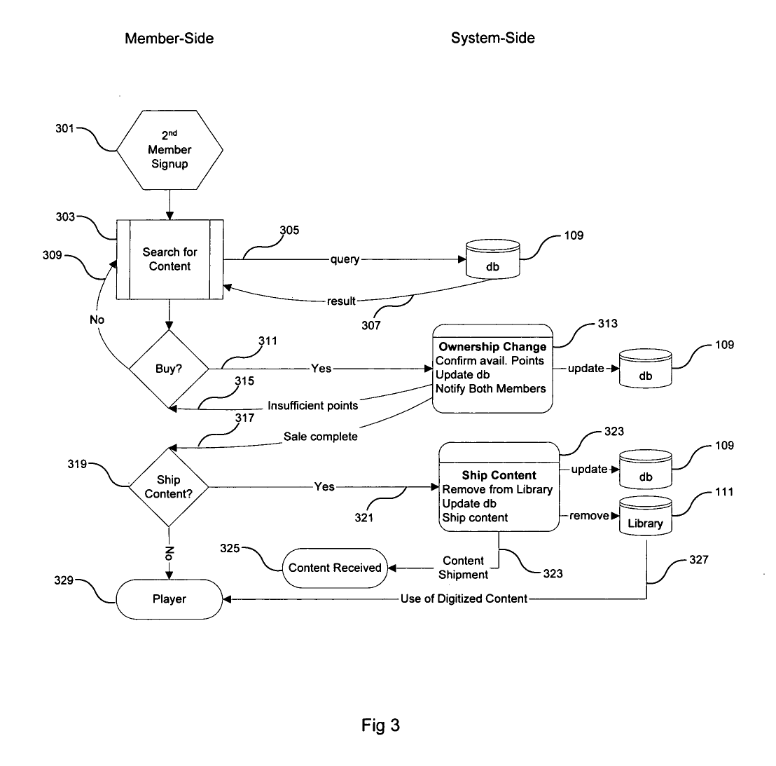

Turning to FIG. 3 a second member may purchase content owned by a first member using the trading system. In step 301 the second member signs up for the service by providing their information.

The second member may search for content available for trading by searching the content database 109. In step 303 the second member composes their search query using one or more fields stored in content database 109, and submits their query in step 305. In step 307 the results of the query are communicated back to the second member. The query results may contain a list of one or more pieces of content stored on the system and the respective number of trading points the owning member desires in exchange for a trade. Additionally, the query results may contain information about on which format or formats the content is available on.

In step 311 the second member's agreement to purchase content from another member is communicated to the system. The system receives the request and confirms in step 313 whether or not the second member has adequate trading points in their account to consummate the sale. Assuming the second member has adequate trading points the content database 109 is updated to reflect the change in ownership, and in step 317 the parties are notified of the sale, trade, or other completed transaction. In the event that the second member does not have enough trading points a notification is sent to the second member in step 315 and the sale is not consummated. The second member may add additional trading points to their account by either paying the system operator money, or by selling some of their content thereby generating additional trading points. The second member may also search for additional content in step 309.

In step 319 after the purchase of content is consummated the second member may elect to have the physical media shipped to them. In this case the second member so notifies the trading system in step 321. The system receives the request to ship the content in step 323 and removes the content from the content library 111, updates the content database 109, and ships the physical content to the second member in step 323. The second member receives their content in step 325 thereby fully completing the transaction.

In the event the second member chooses not to have the physical content shipped to them in step 319, the content remains in the trading system and is available for use by the second member in step 327. The second member may access their content via the content library 111 and may play their content in step 329. Digital player 329 may be located within the member's personal computer as depicted in FIG. 1, or within a mobile device as depicted in FIG. 4 as discussed further below.

Turning to FIG. 4 a member may purchase content from outside system 401 and instruct outside system 401 to send the content directly to the member's account. The third-party system can directly submit the content to the system for inclusion in the members account. Similarly, a member may instruct the system provider to facilitate the purchase of content from third-party systems. The member may value the content either at the time of purchase or at a later time.

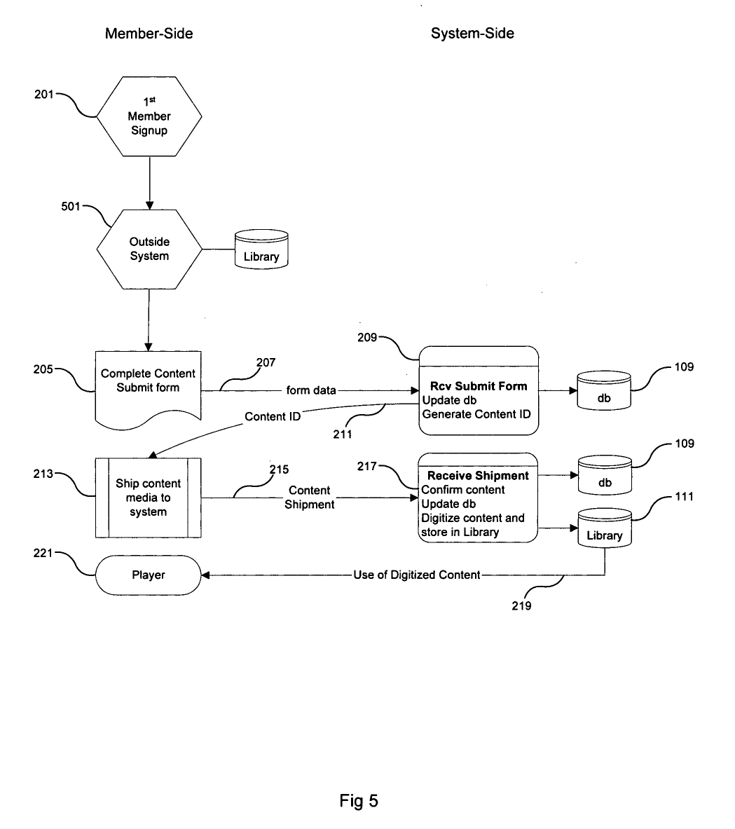

Turning, briefly to FIG. 5, when a member purchases content from an outside system 501 the outside system 501 may transmit the information contained on the content submission form directly to the system either electronically or using the paper form. Outside system 501 may also “ship” the content depicted in step 213 electronically to the system, or it may ship the physical copy of the content to the system as discussed above and depicted in FIG. 2, or both.

Returning to FIG. 4, members may also sell content to other outside systems 401. Purchases and sales may be facilitated by the member by communicating instructions regarding the transaction to the system 101 and having the system 101 communicate directly with the outside system 401 via communications path 403. A private communications session (not shown) may be established between the system 101 and the outside system 401. Data encryption may be employed between the system 101 and the outside system 401.

A member may interact directly with outside system 401 via communication path 403. The outside system 401 may be operated via a user interface system such as web server 405, and may store content in database 407. The member may also interact directly with outside system 401 via mobile device 409. Mobile device 409 could include any mobile device such as a cellular telephone, or other personal communications device. Via the mobile device 409 the member may interact with either the system 101 or outside system 401 to search for and facilitate the sale or purchase of content. If the content purchased is from outside system 401 the content may be delivered to the system 101 for storage in the member's account. Similarly, if the content is sold to outside system 401 (or a member of outside system 401) the content may be delivered to outside system 401 for storage and removed from the member's account. Additionally, via the mobile device 409, or via another communication-capable device, the member may instruct the system to download stored content to mobile device 409. The member may also instruct the system to stream stored content to mobile device 409 from either the mobile device 409 or via another communication-capable device, such as personal computer 123.

1. A media storage system for facilitating the transfer of any one of a plurality of media items between any one of a plurality of members, comprising:
a storage device configured to store a plurality of media items;
a database programmed to
store a plurality of data elements associated with each of the plurality of media items, including a first data element indicating an owner of a stored media item, and second data element indicating a sale value of the media item;
the database being further programmed to
limit access to a media item to its corresponding owner, and
modify the first data element to change the owner of the media item.

2. The media storage system of claim 1 further comprised of a storage repository for storing received physical copies of media items.

3. The media storage system of claim 2 wherein a corresponding physical copy of the media item is in the storage repository for each media item stored in the storage device.

4. The media storage system of claim 3 further comprising a verification device verifying that each media item is an authentic copy of the corresponding physical copy stored in the storage repository.

5. The media storage system of claim 1 further comprising a watermarking device watermarking at least one of the plurality of media items.

6. The media storage system of claim 1 wherein the storage device receives the media item from the at least one of a plurality of outside systems.

7. The media storage system of claim 1 wherein the database is further programmed to store a data element indicating historical ownership information for the media item.

8. The media storage system of claim 1 further comprising a digitizer digitizing non-digital content.

9. The media storage system of claim 8 wherein the digitizer is approximate the owner of the media item.

10. The media storage system of claim 8 wherein the digitizer is remotely located from the media storage system and transmits the digitized media item via a communications path.

11. The media storage system of claim 1 wherein the storage device receives the media item from the at least one of a plurality of outside systems.

12. The media storage system of claim 11 wherein the at least one of a plurality of outside systems is instructed to transmit the media item by a mobile device.

13. The media storage system of claim 1 wherein the media item is played on an electronic device.

14. In a media storage system comprising a storage device configured to store a plurality of media items, a database programmed to store a plurality of data elements associated with each of the plurality of media items, including a first data element indicating an owner of a stored media item, a second data element indicating a point value of the media item, and a third data element indicating the number of points a member has in the member's account, the method of facilitating the transfer of one of the plurality of media items comprising:
providing the point value element for one of the plurality of media items by the owner of the media item;
searching the database and selecting one of the plurality of media items for transfer by a buying member;
verifying that the buying member has at least as many points in the member account as the point value element for the selected media item;
deducting the point value from the buying member's account and crediting the owner's account;
modifying the first data element to the corresponding buying member;
limiting access to the selected media item to the corresponding buying member.

15. The method of claim 14, further comprising storing corresponding physical copies of each of the plurality of media items in a storage repository.

16. The method of claim 15, further comprising verifying each of the plurality of media items is an authentic copy of the corresponding physical copies stored in the repository.

17. The method of claim 15, further comprising shipping the corresponding physical copy of the selected media item to the buying member.

18. The method of claim 14, further comprising modifying a stored data element indicating historical ownership information for the media item.

19. The method of claim 14, wherein the searching the database and selecting one of the plurality of media items is communicated by an electronic device.

20. The method of claim 14, further comprising playing the selected media item on an electronic device.

21. In a media storage system comprising a storage device configured to store a plurality of media items, a database programmed to store a plurality of data elements associated with each of the plurality of media items, including a first data element indicating an owner of a stored media item, a second data element indicating a point value of the media item, and a third data element indicating the number of points a member has in the member's account, the method of facilitating the transfer of one of the plurality of media items comprising:
providing the point value element for a desired one of the plurality of media items by a buying member;
searching the database for the desired one of the plurality of media items for transfer by an owning member;
verifying that the buying member has at least as many points in the member account as the point value element for the selected media item;
deducting the point value from the buying member's account and crediting the owner's account;
modifying the first data element to the corresponding buying member;
limiting access to the selected media item to the corresponding buying member.

22. The method of claim 21, further comprising storing corresponding physical copies of each of the plurality of media items in a storage repository.

23. The method of claim 22, further comprising verifying each of the plurality of media items is an authentic copy of the corresponding physical copies stored in the repository.

24. The method of claim 22, further comprising shipping the corresponding physical copy of the selected media item to the buying member.

25. The method of claim 22, further comprising modifying a stored data element indicating historical ownership information for the media item.

26. The method of claim 21, wherein the searching the database and selecting one of the plurality of media items is communicated by an electronic device.

27. The method of claim 19, further comprising playing the selected media item on an electronic device.

28. In a media storage system comprising a storage device configured to store a plurality of media items, a database programmed to store a plurality of data elements associated with each of the plurality of media items, including a first data element indicating an owner of a stored media item, a second data element indicating a point value of the media item, and a third data element indicating the number of points a member has in the member's account, the method of facilitating the transfer of one of the plurality of media items comprising:
providing an expression of interest in selling one of the plurality of media items by the owner of the media item;
facilitating a bidding process between at least one of a plurality of buying members;
selecting the successful buying member from the at least one of a plurality of buying members;
verifying that the successful buying member has at least as many points in the member account as the point value element for the selected media item;
deducting the point value from the successful buying member's account and crediting the owner's account;
modifying the first data element to the corresponding successful buying member;
limiting access to the selected media item to the corresponding successful buying member.

29. The method of claim 28, further comprising storing corresponding physical copies of each of the plurality of media items in a storage repository.

30. The method of claim 29, further comprising verifying each of the plurality of media items is an authentic copy of the corresponding physical copies stored in the repository.

31. The method of claim 29, further comprising shipping the corresponding physical copy of the selected media item to the buying member.

32. The method of claim 28, further comprising modifying a stored data element indicating historical ownership information for the media item.

33. The method of claim 28, wherein the searching the database and selecting one of the plurality of media items is communicated by an electronic device.

34. The method of claim 28, further comprising playing the selected media item on an electronic device.

35. A method of facilitating the transfer of one of a plurality of media items comprising:
storing a plurality of media items;
maintaining corresponding physical copies of each of the plurality of media items;
associating each of the plurality of media items with a corresponding owner;
limiting access rights to each of the media items based on their corresponding owner;
associating a value with a media item of the plurality of media items;
changing the association of the owner with the media item due to a transfer of ownership in the media item.

36. The method of claim 35, further comprising shipping the corresponding physical copy of the transferred media item.

37. The method of claim 35, further comprising verifying each of the plurality of media items is an authentic copy of the maintained corresponding physical copies.

38. The method of claim 35, further comprising modifying a stored data element indicating historical ownership information for the media item.

39. The method of claim 35, further comprising playing the selected media item on an electronic device.
